(19) United States
(12) Patent Application Publication
(10) Pub. No.: US 2002/0048310 A1
(43) Pub. Date: Apr. 25, 2002

(54) Catheter for thermal and ultrasound evaluation of arteriosclerotic plaque

(76) Inventor: Richard R. Heuser, Phoenix, AZ (US)

Correspondence Address: Kolisch, Hartwell, Dickinson,, McCormack & Heuser, 200 Pacific Building, 520 S.W. Yamhill Street, Portland, OR, 97204, US

(21) Appl. No.: 10/012,978

(22) Filed: Nov. 5, 2001

Related U.S. Application Data
(63) Continuation-in-part of application No. 09/521,091, filed on Mar. 7, 2000.

(51) Int. Cl. G01K 1/14; G01K 13/00; G01K 7/04

(52) U.S. Cl. 374/141; 374/179

(57) ABSTRACT

A device for percutaneous insertion into a fluid passageway of a human body, such as an artery is provided with one or more thermocouples disposed on a flexible, resilient wire lead and coupled to a temperature monitor. The wire lead includes a distal portion formed in a single, oval, looped shape or a double, ovoid or basket-like, looped shape with the thermocouples disposed on a side or tip of the shape. The wire lead is configured, e.g., by insertion in a guidewire, for slidable movement through the artery to an area of interest, e.g., at a buildup of arteriosclerotic plaque, on an inner surface of the artery, to bring the thermocouple into resiliently biased contact with the inner surface at the area of interest for measurement of the temperature there.

### CROSS-REFERENCE TO RELATED APPLICATION(S)

This application is a continuation-in-part of applicant's co-pending patent application Ser. No. 09/521,091 filed Mar. 7, 2000 for “Catheter for Thermal Evaluation of Arteriosclerotic Plaque.”

### BACKGROUND

This invention relates generally to an apparatus and method for detecting and evaluating arteriosclerotic plaque within a human fluid passageway, e.g., a major artery, and for remotely measuring temperature within the passageway, particularly along an interior surface of the passageway. More particularly the invention concerns an apparatus and method for detecting the presence of arteriosclerotic plaque with ultrasound, locating the boundaries of the plaque, assessing whether the plaque is vulnerable to rupture by determining temperature variations at and around the arteriosclerotic plaque within the passageway, and converting vulnerable plaque to stable plaque by heating and destroying inflammatory cells in the plaque.

Coronary heart disease takes two forms, a chronic form and an acute form, the latter being the more dangerous because it involves a buildup of unstable plaque within an artery. The unstable plaque is prone to rupture, which often leads to activation of clotting factors in the bloodstream and formation of a blood clot, possibly resulting in a stroke or myocardial infarction. Furthermore, in acute coronary heart disease, sudden death is the first warning sign in up to 25% of cases. Therefore, clinical trials have been conducted to develop a way to diagnose acute coronary heart disease by assessing the nature of the plaque buildup. The trials have indicated that the amount of plaque, the degree of blood vessel narrowing, and the appearance of the plaque under angiography are not helpful in determining the vulnerability of the plaque to rupture. Thus, new ways to identify and manage dangerous vulnerable plaques could add much to the prevention and treatment of life-threatening acute coronary events.

Stable plaques, called atheromas, have thick fibrous caps, smaller lipid cores, and are less likely to rupture. Unstable plaques, on the other hand, are characterized by thin fibrous caps, weakness in the blood vessel wall, and increased inflammatory cells. Angiography and intravascular ultrasound can be used to detect the presence and size of plaque within coronary vessels. These invasive techniques alone, however, cannot determine the stability and composition of the plaques. Angioscopy, an invasive technique that has shown promise in its ability to detect disruptions in blood vessel linings, is no longer available in the United States. Such invasive techniques carry significant risks and require large bore catheters to accomplish which produce trauma to delicate blood vessels.

Recent investigations have examined plaque temperature as an indicator of plaque instability. Casscells et al. examined blood vessels with plaques taken from human patients who had undergone carotid endarterectomy. Using a thermistor probe with a needle tip, these researchers demonstrated that plaque temperatures varied from 0.5-degrees to 3-degrees C across the surface of the carotid artery plaques. They concluded that temperature variance was related to the accumulation of macrophages, i.e., inflammatory cells, beneath the plaque cap, with higher temperatures associated with greater macrophage buildup.

Stefanadis et al. measured temperature of plaques using a thermography catheter inserted through a guiding catheter within the coronary vessels. Temperature measurements were taken at five locations near five different vessel lesion sites. Their findings indicate that arteriosclerotic plaques showed greater surface temperatures, with the highest temperatures and greatest variation in temperatures present for patients with unstable angina and myocardial infarction.

### SUMMARY OF THE INVENTION

The invented device and method provides for detecting and locating deposits of arteriosclerotic plaque in the artery, for measuring temperature at and around the plaque in the artery, evaluating vulnerability of the plaque as indicated by an increased temperature from the presence of inflammatory cells, and for destroying inflammatory cells, where found in the plaque, by heat treatment, with a minimum degree of risk to delicate blood vessel linings and at a minimum cost for the device. According to the invention, a catheter is provided with an ultrasound probe, typically located adjacent a distal end of the catheter for detection and location of deposits of plaque within the artery by identification of echolucent areas along the artery lining. The catheter also includes a temperature sensor mounted to the catheter adjacent the ultrasound probe, for temperature analysis of the plaque. The temperature sensor typically is a thermocouple mounted on a flexible wire lead mounted to the catheter so as to bias the thermocouple against the artery wall. In another embodiment, a thermocouple is disposed on a flexible, resilient, and very fine wire lead at a distal portion of the lead, and the lead is inserted through a guidewire with the distal portion of the wire lead extending from a distal end of the guidewire, and the guidewire is inserted percutaneously into the fluid passageway. The thermocouple of this embodiment may be used alone or combined with an ultrasound probe.

The distal portion of the wire lead is formed in an oval, looped or basket shape, having a tip and two or more sides with the thermocouple disposed on one of the sides at a point of maximum outer circumference for the oval shape, and/or on the tip. As the distal portion of the wire lead is slidably moved through the passageway through portions of the passageway having an inner circumference less than the outer circumference of the oval shape, the shape flexes resiliently, biasing the thermocouple against the inner surface of the passageway. Thus, the thermocouple is in direct, biased contact with the inner surface for accurate measurement of the surface temperature, with minimum danger of damage to the blood vessel lining.

The thermocouple at the tip of the looped shape is useful to measure the temperature at areas of near-total or total occlusion where the lead cannot pass and, in areas with less plaque, to measure the temperature in the bloodstream adjacent to the plaque surface. The distal portion of the wire lead may also be formed in an L-shape with the thermocouple disposed at the tip of the L.

### BRIEF DESCRIPTION OF THE DRAWINGS

FIG. 1 is a isometric view from the side of the present invention, showing a guidewire and a wire lead inserted through the guidewire, the wire lead including four wires at a distal portion extending beyond a distal end of the guidewire, the distal portion formed in an ovoid basket-shape with thermocouples disposed on one side and on a forward or distal tip of the four-wire basket-shape, the device shown inserted in a plaque-affected fluid passageway, the basket-shape having a maximum outer circumference smaller than a primary inner circumference of the passageway, except at an area of interest where the plaque has narrowed the circumference of the passageway.

FIG. 2 is an isometric view of the guidewire, wire lead and thermocouple of the present invention, this embodiment including only two wires at a distal portion of the wire lead formed in an oval, looped shape with the thermocouple disposed on one side of the looped-shape.

FIG. 3 is an isometric view of the guidewire, wire lead and thermocouple of the present invention, in another embodiment including only two wires at a distal portion of the wire lead formed in an oval, looped shape with the thermocouple disposed on a forward or distal tip of the looped shape.

FIG. 4 is an isometric view of another embodiment of the present invention, including a guidewire, and a wire lead inserted therethrough with a distal portion of the wire lead extending beyond a distal end of the guidewire, the distal portion terminating in an L-shape with a thermocouple disposed at the tip of the L.

FIG. 5 is an isometric view of an embodiment of the present invention, similar to the embodiment in FIG. 1, but with a thermocouple only along a side of the basket-shape.

FIG. 6 is an isometric view of an embodiment of the present invention, similar to the embodiment in FIG. 1, but with a thermocouple only at a forward or distal end or tip of the basket-shape.

FIG. 7 is an isometric view of a catheter constructed in accordance with an embodiment of the present invention, including a guidewire, upon which the catheter is threaded, and including on the catheter an ultrasonic imaging probe, a wire basket comprising four wire leads, with a thermocouple mounted on one of the leads, the wire basket in a contracted position, and an RF probe integrated onto the catheter.

FIG. 8 is an isometric view of the catheter of FIG. 7 with the wire basket in an expanded position.

### DETAILED DESCRIPTION OF THE PREFERRED EMBODIMENTS

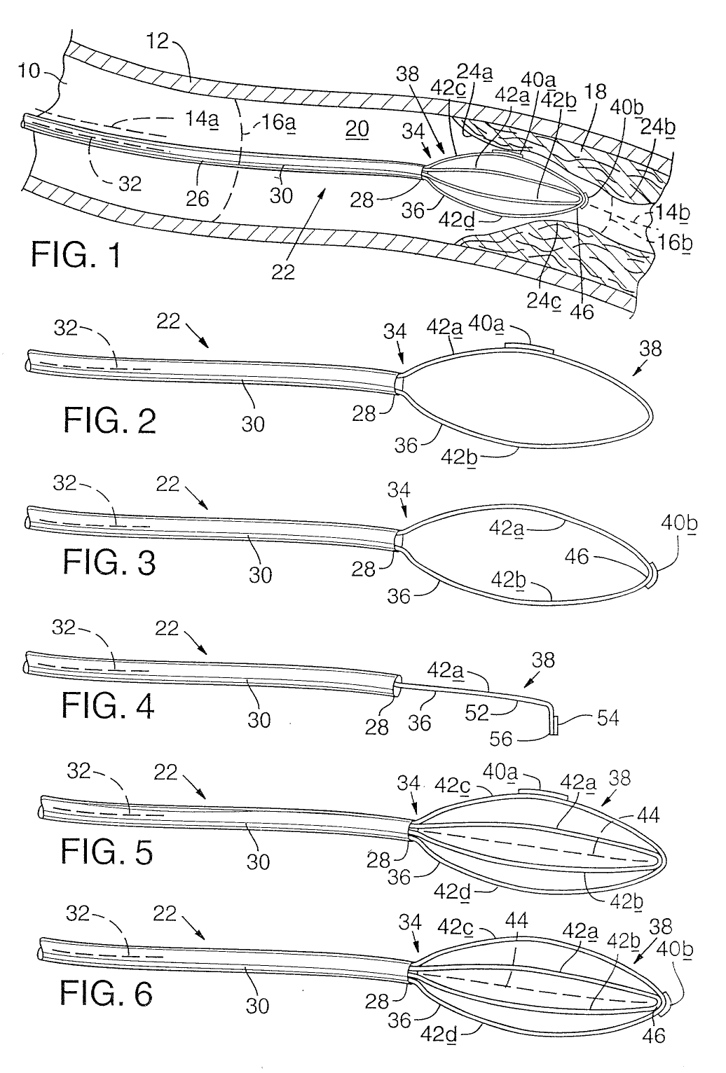

As shown in FIG. 1, a fluid passageway, such as artery 10, is formed of a wall 12 having a generally cylindrical shape and defining a central longitudinal axis 14a and an inner circumference 16a. The position of the axis and the size of the inner circumference vary over the length of artery 10, shifting and narrowing in locations, as shown for axis 14b and inner circumference 16b, where a buildup or a growth 18 of arteriosclerotic plaque has developed on an internal surface 20 of wall 12. Under normal conditions blood is flowing under varying pressure through artery 10. As shown in FIG. 1, the buildup of plaque dramatically narrows the inner diameter of the artery. However, under some conditions, a buildup of plaque, including plaque that is dangerously vulnerable to rupture, does not dramatically narrow the artery. Such unstable plaque, as well as stable plaque, can be detected and its borders determined by ultrasound imaging.

One factor believed to indicate the presence of the unstable plaque of acute coronary heart disease is an increased temperature measurable at the surface of the plaque. Elevated levels of inflammatory cells are believed to cause the increased temperature. A device indicated generally at 22 for measuring temperature along interior surface 20, including at one or more areas of interest, such as those indicated at 24a, 24b, and 24c, where plaque 18 is located, includes a guidewire 26 configured for insertion into artery 10 and sliding movement along the passageway under the control of a physician.

Guidewire 26 is preferably a stainless steel, hollow tube, including an open proximal end (not shown), an open distal end 28, and a generally cylindrical outer surface 30 extending between the ends. The guidewire defines a central longitudinal axis 32. The outer diameter of the guidewire is preferably about 0.014-inches and is typically constant throughout the length of the guidewire. It will be understood that guidewire 26 is provided with a lateral flexibility sufficient for sliding movement through the turns typical for human passageways, but rigid enough that, even at a length of four feet or more, a translational force applied adjacent the proximal end is transmitted to the distal end for sliding motion along the passageway, and that a torsional force applied adjacent the proximal end is likewise transmitted to the distal end to turn the distal end to aid in steering the guidewire.

Guidewire 26 has an inner diameter sufficient to accommodate a wire lead, indicated generally at 34, which is inserted through guidewire 26. Wire lead 34 may be held in place in guidewire 26 by a frictional fit, or adhesively fixed in place. Wire lead 34 can be provided in a variety of different shapes for accurate measurement of temperature under various conditions within the passageway. Wire lead 34 is preferably made of one or more flexible, resilient metal wires 36 designed for medical applications, such as Nitinol® or constantan. Wires 36 are sized for insertion through the guidewire, e.g., as shown in FIGS. 1, 5, and 6, where four wires 36 extend through the guidewire and have an outer diameter of typically about 0.003-inches. In embodiments shown in FIGS. 2 and 3, with two wires 36 extending through guidewire 26, wires 36 are typically about 0.005-inches, and a single wire 36, as shown in FIG. 4, typically is about 0.010-inches in outer diameter. Wires 36 typically extend all the way through guidewire 26, and have proximal ends (not shown) extending beyond the proximal end of guidewire 26, which are configured for connection to a temperature monitor (not shown).

Wire lead 34 is typically inserted into guidewire 26 with a distal portion 38 of wire lead 34 that extends beyond distal end 28 of guidewire 26. If a frictional fit is used for one or more of wires 36, such wires may be moved longitudinally relative to guidewire 26 to vary the length, circumference and shape of distal portion 38.

One or more thermocouples 40a, 40b are disposed on distal portion 38 of wire lead 34, and wires 36 at distal portion 38 are formed in a shape for flexible, resilient positioning of the thermocouples within the passageway. In the embodiment shown in FIGS. 1, 5, and 6, four lengths 42a-d of wire 36 at distal portion 38 are disposed in a looped, ovoid or basket shape, each of wire lengths 42a-d providing a side of the looped, basket shape, and the sides are generally spaced apart at about 90-degree intervals. This embodiment will also be understood to include a first looped shape formed by wire lengths 42a and 42b and a second looped shape formed by wire lengths 42c and 42d wherein the second looped shape is roughly orthogonal to the first looped shape. As shown in FIGS. 5 and 6, wire lead 34 defines a central longitudinal axis 44. Wire lengths 42a-d are flexible and resilient to conform generally to inner circumference 16a, 16b of artery 10 and to position wire lead 34 with its central axis 44 generally coincident with central axis 14a, 14b of artery 10 as wire lead 34 is moved through artery 10. Wire lengths 42a-d may be rigidly fixed together at tip 46.

As shown in FIG. 1, a first thermocouple 40a is positioned on the side of the looped shape of distal portion 38 provided by wire length 42c at a position, typically at a maximum outer circumference of distal portion 38, that is adjacent distal end 28 of guidewire 26 and nominally radially outside of the outer diameter at distal end 28 of guidewire 26. Wire lead 34 is thus configured to bring thermocouple 40a to an area of interest where a temperature measurement is desired within artery 10, such as at plaque inner surfaces 24a, 24b, 24c. Distal portion 38 of wire lead 34, being flexible and resilient, biases thermocouple 40a in a radially outward direction from central axis 44 of wire lead 34 and into contact with the areas of interest 24a, 24b, 24c on inner surface 20 of artery 10 for accurate measurement of the temperature there. Wire lead 34 flexes in response to contact with the interior surface of artery 10 and allows thermocouple 40a to move radially inward from its nominal position.

Thermocouples 40a, 40b are preferably capable of calibration to 0.05-degrees C, so that the thermocouples can sense the temperature remotely within artery 10 and register the temperature on the external temperature monitor so that accurate measurement can be performed.

Guidewire 26 is primarily provided to give sufficient longitudinal and torsional stiffness to device 22, but alternatively guidewire 26 may provide a conductive path between the thermocouple and the temperature monitor for measurement of temperature, or wire lead 34 may be constructed with a portion providing sufficient structural strength, thus incorporating the function of guidewire 26.

The second thermocouple 40b shown in FIG. 1 is positioned at a forward or distal tip 46 of distal portion 38 of wire lead 34, and thus thermocouple 40b may be brought into contact with an area of interest where plaque 18 has completely, or almost completely occluded artery 10 to an extent that wire lead 34 cannot be further inserted. Thermocouple 40b at tip 46 is also useful for measuring the temperature within the blood flow rather than at interior surface 20.

Guidewire 26, wire lead 34, and thermocouple 40 may be constructed in the manner shown in Japanese patent application no. H11-249287, SN-3073999902, of Internova Corporation and Richard R. Heuser, filed on Sep. 2, 1999 and entitled Guidewire for Medical Application, which is hereby incorporated by reference. In that embodiment, guidewire 26 is a stainless steel mandrill having a lengthwise groove into which wire lead 34 is laid and affixed, e.g., by adhesives, and guidewire 26 is one of the conductors connected to the temperature monitor. Wire lead 34 is a single, insulated constantan wire providing the other conductive path to the temperature monitor. Thermocouple 40 is formed by soldering together the constantan wire and the stainless steel guidewire.

In the embodiment of FIGS. 2 and 3, distal portion 38 includes a two-sided looped shape formed by two wire lengths 42a and 42b with a single thermocouple 40a (FIG. 2) or 40b (FIG. 3) disposed on a side or on tip 46, respectively, of distal portion 38. It will be understood that wire lead 34 and guidewire 26 as shown in FIGS. 2 and 3 have similar capabilities as the embodiment of FIGS. 1, 5, and 6 for slidable movement through artery 10 to bring thermocouple 40a to an area of interest within artery 10 at a position nominally radially outside of guidewire axis 32 for radially outwardly biased contact with interior surface 20 at the area of interest for accurate measurement of temperature there. Thermocouple 40b as shown in FIG. 3 operates the same as for the embodiment of FIG. 1, but is provided in a simpler structure for measurement of temperature in the blood stream or at the surface of total or near-total occlusion.

In the embodiment shown in FIG. 4 distal portion 38 of wire lead 34 is a single wire length 42a provided with an L-shape 50 at its terminal end 52, with thermocouple 54 disposed adjacent a tip 56 of L-shape 50. Thermocouple 54 in this embodiment is thus disposed adjacent distal end 28 of guidewire 26 at a position nominally radially outside of the outer diameter of guidewire 26 for biased contact with, and measurement of the temperature of, interior surface 20 of artery 10. The L-shaped tip of this embodiment is also useful in maneuvering wire lead 34 by torsional force applied at the proximal end of guidewire 26, and thereby encouraging tip 56 to enter a desired arterial branch.

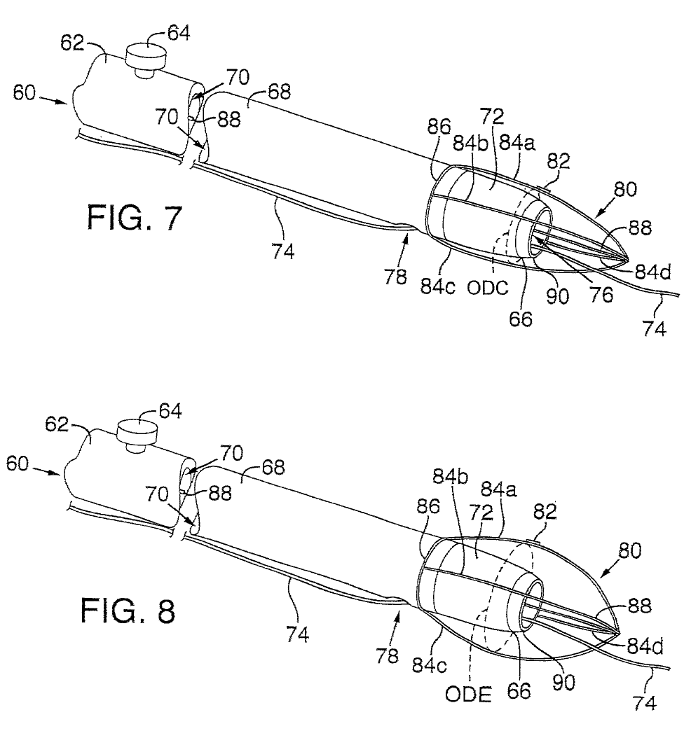

The embodiments of the temperature sensor shown in FIGS. 1 through 6 can be combined with an ultrasound imaging probe and a heating mechanism, for example, by threading an ultrasound imaging catheter, with an integral RF probe for heating, on guidewire 26 and maneuvering the catheter into proximity with the temperature sensor. Another embodiment of such a catheter system is shown in FIGS. 7 and 8, combining a temperature sensor with an ultrasound probe and a localized heating mechanism. In this embodiment a catheter, indicated generally at 60, includes a proximal end 62 with a luer lock 64, a distal end 66, and a body 68 interconnecting the ends and defining an internal lumen 70. Catheter 60 is insertable, distal end first, in a human fluid passageway, such as an artery, for maneuvering therein to areas of interest within the artery.

An ultrasound probe 72 is disposed on catheter 60, typically adjacent distal end 66, and is conventionally coupled through the catheter to an ultrasound monitor so that a physician may view an image of an internal wall of the human passageway in the location of ultrasound probe 72. Catheter 60 may be independently maneuvered in the human passageway to one or more areas of interest, or it may engage a guidewire 74, for example by being threaded on guidewire 74 by inserting the guidewire through an end hole 76 and a side hole 78 in catheter 60, or by other conventional means. The ultrasound probe is typically of sufficient size that a threaded guidewire is preferable to insertion through a hollow guidewire, such as guidewire 26, although a properly sized probe inserted through a hollow guidewire can be used.

Once ultrasound probe 72 has been maneuvered to the area of interest, the physician can locate areas of plaque, which are identified as an echolucent area along the artery wall. That is because plaque cells typically do not reflect the ultrasound waves, as do normal cells lining the artery walls, and thus the plaque appears on the ultrasound monitor as blank spots. Furthermore, the physician may identify the outline or border of the plaque, which is identified as a shoulder, or thin area of lining around the blank spot of the plaque.

Catheter 60 includes in the embodiment shown in FIGS. 7 and 8 a temperature sensor, such as a wire basket, indicated generally at 80, disposed around distal end 66 of catheter 60. Wire basket 80 of FIGS. 7 and 8 is similar to wire basket 38 shown in FIGS. 5, 6, and 7, but it will be understood that any structure for mounting the temperature sensor may be combined with the ultrasound probe. The temperature sensor includes a thermocouple 82 mounted on one of four wire leads 84a-d of wire basket 80, preferably in sufficient proximity to the ultrasound probe to permit measuring of temperature on the artery inner wall at a deposit of plaque contemporaneously with the ultrasound identification of the outline of the deposit of plaque. Alternatively, the ultrasound probe and the temperature sensor may be separated, with imaging and temperature measurements performed independently.

Wire basket 80 is affixed to catheter 60 by a base loop 86 of wire or other suitable material that may be frictionally or adhesively coupled to catheter 60. Wire basket 80 is coupled to a central wire 88, providing an optional path for one or more conductors connecting the thermocouple to an external temperature monitor. Wire basket 80 defines an outer diameter, labeled ODC in FIG. 7 and ODE in FIG. 8.

Central wire 88 extends through catheter 60 to its distal end, where, in addition to coupling to the monitor, central wire 88 allows the physician to move wire basket 80, and thus adjust the outer diameter of wire basket 80, between a contracted position, as shown in FIG. 7, wherein wire leads 84a-d are drawn in close to the outer diameter of catheter 60, and an expanded position, as shown in FIG. 8, wherein wire leads 84a-d are spread out from catheter 60. The expanded position is preferred for measuring temperature at the area of interest, because it tends to bring thermocouple 82 into contact with the deposit of plaque on the artery wall, but temperature measurements may also be made in the contracted position, and that may be preferred for measuring plaque temperature for some arterial conditions. The contracted position is also useful for measuring blood stream temperature at the area of interest or elsewhere because it typically moves thermocouple 82 to a position separated from the artery wall.

The physician's measuring temperature at a deposit of plaque allows evaluation of the stability of the plaque, because inflammatory cells that make the plaque vulnerable to rupture also produce an elevated temperature in the plaque, measurable by the temperature sensor at the inner artery wall. Where such inflammatory cells are found, they can be damaged by temporary heating to a temperature preferably between about 40° and about 45° C., resulting in aphthosis or blistering. The aphthosis tends to stabilize the vulnerable plaque, but the surrounding normal cells are typically not damaged by the temporary heating.

Catheter 60 may include a heating mechanism, such as a conventional RF probe 90, disposed adjacent distal end 66 and integrated with, or in proximity to the ultrasound probe and temperature sensor for heating of a deposit of vulnerable plaque contemporaneously with location of the deposit by ultrasound and temperature measurements. RF probe 90 will be capable of producing the preferred temperatures of between about 40° and about 45° C. in an area confined to the vulnerable plaque, which temperature rise maybe monitored by the temperature sensor. Alternatively, RF probe 90 may be disposed elsewhere on catheter 60 or be incorporated on wire basket 80, separately threaded on guidewire 74, inserted through internal lumen 70 of catheter 60, or otherwise configured for insertion into the artery and maneuvering to the plaque for heat treatment in connection with the ultrasound imaging and temperature measurement. Alternatively, another conventional heating mechanism other than an RF probe may be integrated with catheter 60.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also included within the subject matter of the inventions of the present disclosure.

I claim:

1. A catheter system for use in detecting an area of interest within a human fluid passageway, the catheter system comprising:
a catheter having a proximal end and a distal end, the distal end configured for insertion into the human fluid passageway;
an ultrasound probe coupled to the catheter, the ultrasound probe configured to be maneuvered to the area of interest within the human fluid passageway and to provide imaging of the area of interest; and a temperature sensor disposed adjacent the ultrasound probe for measurement of temperature adjacent the area of interest.

2. The catheter system of claim 1 further comprising a heating mechanism configured to be inserted into the human fluid passageway and maneuvered to the area of interest for heat treatment of the area of interest.

3. The catheter system of claim 2 further wherein the heating mechanism is operable to heat the area of interest to at least about 40° C.

4. The catheter system of claim 2 further wherein the heating mechanism is operable to heat the area of interest to between about 40° C. and about 45° C.

5. The catheter system of claim 2 wherein the heating mechanism is an RF probe.

6. The catheter system of claim 2 wherein the heating mechanism is incorporated into the ultrasound probe.

7. The catheter system of claim 2 wherein the heating mechanism is incorporated into the temperature sensor.

8. The catheter system of claim 1 further comprising a guidewire insertable and maneuverable in the human fluid passageway, and wherein the catheter is configured to engage the guidewire for maneuvering the catheter to the area of interest within the human fluid passageway.

9. The catheter system of claim 6 wherein the catheter includes an opening at its distal end and a side opening adjacent the distal end and the catheter engages the guidewire by insertion of the guidewire through the distal and side openings.

10. The catheter system of claim 1 wherein the ultrasound probe is disposed adjacent the distal end of the catheter.

11. The catheter system of claim 1 wherein the temperature sensor includes a wire disposed external to the catheter and a thermocouple disposed on the wire.

12. The catheter system of claim 1 wherein the temperature sensor includes a wire basket disposed around the distal end of the catheter.

13. The catheter system of claim 12 wherein the temperature sensor includes a wire coupled to the wire basket.

14. The catheter system of claim 13 wherein the wire basket defines an outer diameter and the wire coupled to the wire basket is configured to adjust the outer diameter of the wire basket between an expanded and a contracted position.

15. A catheter system for location and heat treatment of an area of interest within a human fluid passageway, the catheter system comprising:
a catheter having a proximal end and a distal end, the distal end configured for insertion into the human fluid passageway;
an ultrasound probe coupled to the catheter, the ultrasound probe configured to be maneuvered to the area of interest within the human fluid passageway and to provide imaging of the area of interest;
a temperature sensor disposed adjacent the ultrasound probe for measurement of temperature adjacent the area of interest; and
a heating mechanism configured to be inserted into the human fluid passageway and maneuvered to the area of interest for heat treatment of the area of interest.

16. The catheter system of claim 15 further wherein the heating mechanism is an RF probe configured to be inserted through the catheter to the area of interest in the human fluid passageway.

17. The catheter system of claim 15 further wherein the heating mechanism is operable to heat the area of interest to between about 40° C. and about 45° C.

18. The catheter system of claim 15 wherein the heating mechanism is incorporated in one of the ultrasound probe and the temperature sensor.

19. The catheter system of claim 15 further comprising a guidewire insertable and maneuverable in the human fluid passageway, and wherein the catheter is configured to engage the guidewire for maneuvering the catheter to the area of interest within the human fluid passageway.

20. A catheter system for use in examining an area of interest within a human fluid passageway, the catheter system comprising:
a catheter having a proximal end and a distal end, the distal end configured for insertion into the human fluid passageway;
an ultrasound probe coupled to the catheter, the ultrasound probe configured to be maneuvered to the area of interest within the human fluid passageway and to provide imaging of the area of interest; and
a temperature sensor disposed adjacent the ultrasound probe sufficiently close to the ultrasound probe to allow imaging of the area of interest and measurement of the area of interest without movement of the catheter.
